(19) United States
(12) Patent Application Publication
(10) Pub. No.: US 2017/0328119 A1
(43) Pub. Date: Nov. 16, 2017

(54) INSULATING GLAZING UNIT

(71) Applicant: SAINT-GOBAIN GLASS FRANCE, Courbevoie (FR)

(72) Inventors: Hans-Werner KUSTER, AACHEN (DE); Walter SCHREIBER, AACHEN (DE); Marc MAURER, Saint-Jorioz (FR)

(21) Appl. No.: 15/531,730

(22) PCT Filed: Dec. 1, 2015
(86) PCT No.: PCT/EP2015/078145

§ 371 Date: May 30, 2017

(30) Foreign Application Priority Data
Dec. 8, 2014 (EP) 14196707.5

(51) Int. Cl. E06B 3/663

(52) U.S. Cl. CPC E06B 3/663; E06B 3/66366; E06B 3/66352; E06B 2003/66395

(57) ABSTRACT

An insulating glazing unit, having a first pane, a second pane, and a third pane and a circumferential spacer is described. The spacer includes a polymeric main body described as a first pane contact surface and a second pane contact surface, a first hollow chamber and a second hollow chamber, an outer surface a groove to accommodate a pane where the lateral flanks of the groove are formed by the walls of the first hollow chamber and of the second hollow chamber, the outer surface is divided into a first outer surface, a second outer surface, and a bearing edge, the bearing edge runs substantially perpendicular to the pane contact surfaces and connects the first outer surface and the second outer surface to one another, the first outer surface and the second outer surface enclose in each case an angle α (alpha) of 100°<α<160° with the bearing edge, where wherein the panes are connected via one seal each to the pane contact surfaces, the third pane is inserted into the groove of the spacer (I).

The thermal conductivity of glass is lower by roughly a factor of 2 to 3 than that of concrete or similar building materials. However, since, in most cases, panes are designed significantly thinner than comparable elements made of brick or concrete, buildings frequently lose the greatest share of heat via external glazing. The increased costs necessary for heating and air-conditioning systems make up a part of the maintenance costs of a building that must not be underestimated. Moreover, as a consequence of more stringent construction regulations, lower carbon dioxide emissions are required. Triple insulating glazing units, without which, primarily as a result of increasingly rapidly rising prices of raw materials and more stringent environmental protection constraints, it is no longer possible to imagine the building construction sector, are an important approach to a solution for this. Consequently, triple iinsulating glazing units constitute an increasingly larger part of the outward directed glazing units.

Triple insulating glazing units usually include three panes made of glass or polymeric materials that are separated from one another by two individual spacers. A further pane is placed on a double glazing unit using an additional spacer. During assembly of such a triple glazing unit, very small tolerance specifications apply since the two spacers must be installed at exactly the same height. Thus, compared to double glazing units, the assembly of triple glazing units is significantly more complex since either additional system components must be provided for the assembly of another pane or a time-consuming multiple pass through a conventional system is necessary. As an alternative to two individual spacers, spacers are used in which the middle pane is accommodated in an indentation. Such spacers, which can accommodate a third pane in a groove, have the advantage that only a single spacer must be installed, and, hence, the step of alignment of two individual spacers in the prior art triple glazing units is eliminated. The spacer with an integrated middle pane can also be processed on a system for assembly of double glazing units.

WO 2010/115456 A1 discloses a hollow profile spacer with a plurality of hollow chambers for multiple glass panes comprising two outer panes and one or a plurality of middle panes that are installed in a groove-shaped accommodating profile. The spacer can be produced either from polymeric materials or even be made of rigid metals, such as stainless steel or aluminum. The outer surface of the spacer runs substantially perpendicular to the panes of the insulating glazing unit. In the finished insulating glazing unit, a secondary sealant is installed in the outer interpane space, which is delimited by the two outer panes and the outer surface of the spacer. The entire outer surface is covered by the secondary sealant.

DE 10 2009 057 156 A1 describes a triple insulating glazing unit, which includes a shear-resistant spacer, which is bonded with a high-tensile adhesive to two outer panes in a shear-resistant manner. The entire outer surface of the spacer disclosed runs perpendicular to the panes of the insulating glazing unit. The outer interpane space is filled with a secondary sealant.

One object of the present invention is to provide an improved insulating glazing unit as well as an economical method for assembly of an insulating glazing unit according to the invention.

The object of the present invention is accomplished according to the invention by an insulating glazing unit according to the independent claim 1. Preferred embodiments of the invention emerge from the subclaims.

Another independent object of the invention is a spacer suitable for an insulating glazing unit according to the invention.

The insulating glazing unit comprises at least a first pane, a second pane and a third pane and a circumferential spacer arranged between the first and the second pane. The spacer for the insulating glazing unit according to the invention comprises at least a polymeric main body, which has a first pane contact surface and a second pane contact surface running parallel thereto, a first glazing interior surface, a second glazing interior surface, and an outer surface. A first hollow chamber and a second hollow chamber as well as a groove are introduced into the polymeric main body. The groove runs parallel to the first pane contact surface and the second pane contact surface and serves to accommodate a pane. The first hollow chamber is adjacent the first glazing interior surface, while the second hollow chamber is adjacent the second glazing interior surface, with the glazing interior surfaces situated above the hollow chambers and the outer surface situated below the hollow chambers. In this context, “above” is defined as facing the inner interpane space of the insulating glazing unit and “below” is defined as facing away from the interpane space. Since the groove runs between of the first glazing interior surface and the second glazing interior surface, it delimits them laterally and separates the first hollow chamber and the second hollow chamber from one another. The flanks of the groove are formed by the walls of the first hollow chamber and of the second hollow chamber. The groove forms an indentation that is suitable to accommodate the middle pane (third pane) of the insulating glazing unit. Thus, the position of the third pane is fixed by two lateral flanks of the groove as well as the bottom surface of the groove. The outer surface of the polymeric main body is divided into three sub-regions: a first outer surface, a second outer surface, and a bearing edge. The bearing edge is situated at least below the groove. The first outer surface is situated below the first hollow chamber and the second outer surface is situated below the second hollow chamber. The bearing edge runs substantially perpendicular to the pane contact surfaces and connects the first outer surface and the second outer surface to one another. The first outer surface connects the bearing edge and the first pane contact surface. The second outer surface connects the bearing edge and the second pane contact surface. The first outer surface and the second outer surface enclose in each case an angle α (alpha) between 100° and 160° with the bearing edge. This angled geometry increases the stability of the polymeric main body.

The first pane of the insulating glazing unit according to the invention is bonded to the first pane contact surface of the spacer via a seal, while the second pane is bonded to the second pane contact surface via a seal. The seal is mounted between the first pane and the first pane contact surface and the second pane and the second pane contact surface. The third pane is inserted into the groove of the spacer. The first pane and the second pane are arranged parallel and congruently. The edges of the two panes are, consequently, arranged flush in the edge region, in other words, they are situated at the same height. The spacer is inserted such that the bearing edge is situated at the same height as the edges of the two panes and is thus arranged flush with them. In this arrangement, the pane and the first outer surface of the polymeric main body delimit a first outer interpane space. The second pane and the second outer surface of the polymeric main body delimit a second outer interpane space. The two outer interpane spaces separated from one another are at least partially filled with an outer seal. The outer seal is mounted adjacent the respective seal in the first or the second outer interpane space. Thus, the sealing of the edge bond can be improved. A plastic sealing compound, for example, is used as the outer seal. Since the material of the polymeric main body has lower thermal conductivity than the outer seal, a thermal separation occurs due to the separated outer interpane spaces. The thermal decoupling results in an improved PSI value (the linear heat transfer coefficient) and, thus, in an improvement of the thermal insulating properties of the edge bond of the insulating glazing unit compared to prior art insulating glazing units. With prior art insulating glazing units, a single outer interpane space delimited by the first pane, second pane, and outer surface of the spacer is completely filled with the material of the outer seal.

The bearing edge of the spacer also enables simplification of the insulating glazing production with the spacer for the insulating glazing unit according to the invention. During production of an insulating glazing unit using spacers with an integrated third pane in accordance with the prior art, the following problem occurs: For insulating glazing production, the middle pane is preassembled in the groove of the spacer and this spacer frame is glued between the two outer glazings using a sealant. The spacer frame with an integrated middle pane is held in position by the adhesive bond between the spacer and the outer glazings during this period. In the case of the commercially available spacer frames without an integrated glass pane, this adhesive bond suffices. In contrast, the adhesive bond fails in the case of a spacer with an integrated middle pane due to the additional weight of the integrated pane, and the spacer frame sags downward during the insulating glazing production. In order to prevent sagging of the middle glazing, the frame must be additionally supported during the process, rendering the assembly of the insulating glazing unit significantly more difficult. In the following step, an outer seal is installed and the glass is placed on a frame to dry. The material of the outer seal is initially soft and typically only cures over a period of, typically, a few hours. Especially with large, heavy panes, a slippage of the spacer frame with a middle glazing occurs during this stage, since the sealing compound is still soft and can be displaced. The bearing edge of the spacer for the insulating glazing unit according to the invention is provided to be arranged flush with the two edges of the outer panes in the finished insulating glazing unit. Accordingly, the bearing edge supports the spacer frame with an integrated middle glass during the production of a insulating glazing pane and thus prevents sagging of the spacer frame. The insulating glazing unit according to the invention is thus lighter and producible in better quality than an insulating glazing unit according to the prior art.

Another advantage of the spacer for the insulating glazing unit according to the invention relates to the volume of the hollow chambers that are preferably filled with a desiccant. At the same distance from the glazing interior surface to the edge of the insulating glass pane, the spacer for the insulating glazing unit according to the invention has larger hollow chambers than the spacers for prior art insulating glazing units. Since the service life of an insulating glazing unit also depends on the amount of desiccant, the service life of the insulating glazing unit according to the invention can thus be extended.

Thus, the invention makes available an insulating glazing unit with a one-piece double spacer with improved properties, which enables simplified and precise assembly in an insulating glazing unit. The two outer panes (first pane and second pane) are mounted on the pane contact surfaces, while the middle pane (third pane) is inserted into the groove. Since the polymeric main body is formed as a hollow profile, the lateral flanks of the hollow chambers are flexible enough, on the one hand, to yield at the time of insertion of the pane into the groove and, on the other, to fix the pane without stress. The bearing edge of the spacer serves to support the spacer frame with an integrated third pane after the adhesive bonding of the first and second pane to the pane contact surfaces. Thus, slippage of the spacer frame before and after pressing or during curing of the outer seal is prevented. The spacer of the insulating glazing unit according to the invention thus enables simplified yet precise assembly of the triple glazing unit. In addition, by means of the angled first and second outer surfaces, increased stability of the polymeric main body is achieved. Moreover, the hollow chambers have, at an equal distance between glazing interior surfaces and edges of the outer panes, an increased volume, which is preferably filled with desiccant. Thus, the service life of an insulating glazing unit according to the invention is improved.

At the corners of the insulating glazing unit, the spacers are preferably linked to one another via corner connectors. Such corner connectors can be implemented, for example, as a molded plastic part with a seal, in which two spacers provided with a miter cut abut. In principle, various geometries of the insulating glazing unit are possible, for example, rectangular, trapezoidal, and rounded shapes. To produce round geometries, the spacer according to the invention can be bent, for example, in the heated state.

The seal preferably contains a polyisobutylene. The polyisobutylene can be a cross-linking or a non-cross-linking polyisobutylene.

The outer seal preferably contains polymers or silane-modified polymers, particularly preferably organic polysulfides, silicones, room temperature vulcanizing (RTV) silicone rubber, peroxide vulcanizing silicone rubber, and/or addition vulcanizing silicone rubber, polyurethanes, and/or butyl rubber.

The first pane, the second pane, and/or the third pane of the insulating glazing unit preferably include glass and/or polymers, particularly preferably quartz glass, borosilicate glass, soda lime glass, polymethylmethacrylate, and/or mixtures thereof.

Preferably, the gas- and vapor-tight barrier is covered with a thin film made of the material of the outer seal. Preferably, the thin-film has a thickness of 0.5 mm to 1 mm. The thin-film protects the gas- and vapor-tight barrier from damage, in particular in the region of the bearing edge, for example, during assembly. Since it is a very thin film, the effect of the thermal decoupling by the separation of the outer interpane spaces is not impaired.

The first pane and the second pane have a thickness of 2 mm to 50 mm, preferably 3 mm to 16 mm, with the two panes also possibly having different thicknesses. The third pane has a thickness of 1 mm to 4 mm, preferably of 1 mm to 3 mm, and particularly preferably of 1.5 mm to 3 mm. The spacer for the insulating glazing unit according to the invention enables, by means of tension-free fixing, an advantageous reduction of the thickness of the third pane while maintaining stability of the glazing unit. Preferably, the thickness of the third pane is less than the thicknesses of the first and second pane. In a possible embodiment, the thickness of the first pane is 3 mm, the thickness of the second pane is 4 mm, and the thickness of the third pane is 2 mm. Such an asymmetric combination of the pane thicknesses results in a significant improvement of the acoustic damping.

Multiple panes can also be implemented as composite glass panes.

The insulating glazing unit is filled with a protective gas, preferably with a noble gas, preferably, argon or krypton, which reduce the heat transfer value in the insulating glazing unit interspace.

The third pane of the insulating glazing unit preferably has a low-E coating. With low-E coatings, the thermal insulation capacity of the insulating glazing unit can be increased even more and improved. These coatings are thermal radiation reflecting coatings that reflect a significant portion of the infrared radiation which, in summer, results in reduced warming of the living space. Various low-E coatings are known, for example, from DE 10 2009 006 062 A1, WO 2007/101964 A1, EP 0 912 455 B1, DE 199 27 683 C1, EP 1 218 307 B1, and EP 1 917 222 B1.

The third pane of the insulating glazing unit is preferably not prestressed. By eliminating the prestressing process, the production costs can be reduced. Furthermore, the pane is fixed in the groove with flexible lateral flanks and not by adhesive bonding. Thus, the spacer in the insulating glazing unit according to the invention enables the production of a triple glazing unit with a low-E coating on the third pane, without prestressing of the third pane being necessary. With adhesive bonding or with an otherwise rigid locking of the pane, the heating of the pane caused by the low-E coating would favor a failure of the adhesive bond. Furthermore, prestressing of the third pane would be necessary to compensate for arising stresses. However, with the insulating glazing unit according to the invention, the prestressing process is eliminated, by which means a further cost reduction can be achieved. By means of the tension-free fixing in the groove, the thickness and, hence, the weight of the third pane can also be advantageously reduced.

In a preferred embodiment of the insulating glazing unit according to the invention, the outer seal in installed such that it covers the part of the first pane that delimits the first outer interpane space by at least 90%, covers the part of of the second pane that delimits the second outer interpane space by at least 90%, covers the first outer surface and the second outer surface in each case by at least 40% and at most a 60%. In this arrangement, good sealing of the spacer is achieved. Moreover, in the arrangement described, good mechanical stabilization of the edge bond is done by the outer seal. At the same time, compared to the complete filling of the outer interpane spaces, outer seal and, thus, material costs can be saved.

In an alternative preferred embodiment, the outer interpane spaces are completely filled with an outer seal. By this means, very good mechanical stabilization of the edge bond is achieved.

In a preferred embodiment of the insulating glazing unit according to the invention, at least one insert is installed in the groove such that a gas exchange is possible between the two inner interpane spaces. Thus, pressure equalization between the inner interpane spaces is enabled, which, compared to an embodiment with hermetically sealed inner interpane spaces, results in a significant reduction in the loading of the third pane.

In the following, other advantages and properties of the spacer for the insulating glazing unit according to the invention are specified.

The hollow chambers of the spacer for the insulating glazing unit according to the invention contribute not only to the flexibility of the lateral flanks but also result in a weight reduction compared to a solidly formed spacer and are available to accommodate other components, such as a desiccant.

The first pane contact surface and the second pane contact surface constitute the sides of the spacer, on which, during the installation of the spacer, the mounting of the outer panes (first pane and second pane) of an insulating glazing unit is done. The first pane contact surface and the second pane contact surface run parallel to one another.

The glazing interior surfaces are defined as the surfaces of the polymeric main body, which face, after installation of the spacer in an insulating glazing unit, in the direction of the interior of the glazing. The first glazing interior surface is between the first and the third pane, while the second glazing interior surface is arranged between the third and the second pane.

The outer surface of the polymeric main body is the side opposite the glazing interior surfaces, which faces away from the interior of the insulating glazing unit in the direction of an outer insulating layer.

in prior art insulating glazing units, the distance between between glazing interior surfaces and the edges of the outer panes of the insulating glazing unit corresponds to the sum of the overall height of the spacer and the thickness of the layer made of an outer sealing compound. With the use of the spacer in the insulating glazing unit according to the invention, the distance between the glazing interior surfaces and the edges of the outer panes corresponds to the overall height hG of the polymeric main body. Due to the angled geometry of the first and second outer surface, the depth of the groove h_{N} is larger in comparison to spacers for prior art insulating glazing units, since with the same distance between the glazing interior surfaces and the edges of the outer panes of an insulating glazing unit, a greater depth of the groove h_{N} can be obtained. Preferably, the bottom surface of the groove is directly adjacent the bearing edge of the polymeric main body, without one or both hollow chambers extending below the groove. Thus, the greatest possible depth of the groove h_{N} is obtained, by which means the surface of the lateral flanks for stabilization of the pane is maximized. Thus, improved stabilization of the middle pane is achieved.

Preferably, the angle α (alpha) is between 130° and 150°. With these angles, an optimum enlargement of the hollow chambers is achieved, with simultaneous stabilization of the main body.

In a preferred embodiment, a gas- and vapor-tight barrier is mounted on the first outer surface, the second outer surface, the bearing edge of the polymeric main body, and at least a part of the pane contact surfaces. The gas- and vapor-tight barrier improves the tightness of the spacer against gas loss and penetration of moisture. Preferably, the barrier is applied on roughly one half to two thirds of the pane contact surfaces.

In a preferred embodiment, the gas- and vapor-tight barrier is implemented as a film. This barrier film includes at least one polymeric layer as well as one metallic layer or one ceramic layer. The layer thickness of the polymeric layer is between 5 μm and 80 μm, while metallic layers and/or ceramic layers with a thickness of 10 nm to 200 nm are used. Within the layer thickness is mentioned, particularly good tightness of the barrier film is obtained. The barrier film can be applied on the polymeric main body, for example, glued on. Alternatively, the film can be coextruded together with the main body.

Particularly preferably, the barrier film includes at least two metallic layers and/or ceramic layers, which are arranged alternatingly with at least one polymeric layer. The layer thicknesses of the individual layers are preferably as described in the preceding paragraph. Preferably, the outer layers are formed by the polymeric layer. In this arrangement, the metallic layers are particularly well protected against damage. The alternating layers of the barrier film can be bonded or applied by various methods known in the prior art. Methods for depositing metallic or ceramic layers are well known to the person skilled in the art. The use of a barrier film with an alternating layer sequence is particularly advantageous with regard to the tightness of the system. A defect in one of the layers does not result in a loss of function of the barrier film. By comparison, in the case of a single layer, one small defect can already result in a complete failure. Furthermore, the application of multiple thin layers is advantageous compared to a thick layer since with increasing layer thickness, the risk of internal adhesion problems increases. Also, thicker layers have higher conductivity such that such a film is less suitable thermodynamically.

The polymeric layer of the film preferably includes polyethylene terephthalate, ethylene vinyl alcohol, polyvinylidene chloride, polyamides, polyethylene, polypropylene, silicones, acrylonitriles, polyacrylates, polymethyl acrylates, and/or copolymers or mixtures thereof. The metallic layer preferably includes iron, aluminum, silver, copper, gold, chromium, and/or alloys or oxides thereof. The ceramic layer of the film preferably includes silicon oxides and/or silicon nitrides.

In an alternative preferred embodiment, the gas- and vapor-tight barrier is preferably implemented as a coating. The coating includes aluminum, aluminum oxides, and / or silicon oxides and is preferably applied by a PVD method (physical vapor deposition). By this means, the production method can be significantly simplified since the polymeric main body is provided, for example, by extrusion, with the barrier coating directly after production and no separate step is necessary for the application of a film. The coating with the materials mentioned delivers particularly good results in terms of tightness and, in addition, presents excellent adhesion properties relative to the outer seal materials used in insulating glazing units.

The groove corresponds in its width to at least the thickness of the pane to be inserted.

Preferably, the groove is wider than the pane mounted therein such that, in addition, an insert that prevents slippage of the pane and development of noise caused thereby during opening and closing of the window can be inserted into the groove. Furthermore, the Insert compensates the thermal expansion of the third pane during heating such that, independent of the climate conditions, a stress free fixing is ensured. Moreover, the use of an insert is advantageous with regard to minimizing the number of variants of the spacer. In order to keep the number of variants as low as possible and to nevertheless enable a variable thickness of the middle pane, one spacer can be used with different inserts. The variation of the insert is significantly more favorable in terms of production costs than the variation of the spacer. The insert preferably includes an elastomer, particularly preferably a butyl rubber.

The Insert is preferably mounted such that the first inner interpane space, which is located between the first pane and the third pane, is connected to the second inner interpane space, which is located between the third pane and the second pane, such that an air or gas exchange it is possible. This enables pressure equalization between the inner interpane spaces, which, in comparison with an embodiment with hermetically sealed inner interpane spaces, results in a significant reduction of the load on the third pane. In order to enable this pressure equalization, the insert is preferably mounted at intervals in the groove of the polymeric main body. In other words, the Insert is not mounted continuously along the entire spacer profile, but only in individual regions in which the pane is fixed, in order to prevent rattling of the pane in the groove. Pressure equalization can occur in the regions without an insert. Alternatively, the insert is made from a gas-permeably implemented material, for example, a porous foam, by means of which pressure equalization between inner interpane spaces is also possible.

In another preferred embodiment, the spacer is mounted in the groove without an insert. Preferably, the wall thickness d′ of the lateral flanks is reduced in comparison with the wall thickness d of the polymeric main body, thus creating increased flexibility of the lateral flanks. When d′ is selected smaller than d, the flexibility of the lateral flanks can be increased such that they compensate thermal expansion of the third pane even without the use of an insert and, and hence, tension-free fixing is always ensured. It has been demonstrated that a wall thickness of the lateral flanks of d′<0.85 d, preferably of d′ <0.7 d, particularly preferably of d′ <0.5 d, is particularly suitable for this. When no insert is fitted into the groove, the first interpane space and the second interpane space are not air-tightly sealed from one another. This has the advantage that air circulation can be generated, in particular when a pressure equalization system is integrated into the spacer.

In another preferred embodiment, the embodiments described are combined, wherein an insert is used and the wall thickness of the lateral flanks is reduced as well. Thus, compensation of the thermal expansion of the third pane is done both through the flexibility of the lateral flanks and also through the insert. At the same time, the possibility remains of varying the thickness of the third pane to a certain extent and compensating this through the selection of the insert. In an advantageous embodiment , the insert is formed directly on the polymeric main body and, thus, designed in one piece therewith, with the polymeric main body and the Insert being coextruded. Alternatively, it would also be conceivable to form the insert directly on the polymeric main body, for example, by manufacturing both components together in one two-component injection molding process.

The lateral flanks of the groove can either run parallel to the pane contact surfaces or be inclined in one direction or another. By means of an inclination of the lateral flanks in the direction of the third pane, a taper is produced which can serve to selectively fix the third pane. Furthermore, arched lateral flanks are also conceivable, wherein only the middle section of the lateral flanks rests against the third pane. Such arching of the lateral flanks is particularly advantageous in conjunction with a reduced wall thickness d′ of the lateral flanks. The arched lateral flanks have a very good spring effect, in particular with low wall thicknesses. As a result, the flexibility of the lateral flanks is further increased such that thermal expansion of the third pane can be compensated particularly advantageously. In a preferred embodiment, the arched lateral flanks of the pane are made from a different material from the polymeric main body and coextruded therewith. This is particularly advantageous since, thus, the flexibility of the lateral flanks can be selectively increased by the selection of a suitable material, while the stiffness of the polymeric main body is retained.

The polymeric main body preferably contains polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof. Particularly good results are obtained with these materials.

Preferably, the polymeric main body is glass fiber reinforced. The coefficient of thermal expansion of the main body can be varied and adapted by the selection of the glass fiber content in the main body. By adaptation of the coefficient of thermal expansion of the polymeric main body and of the barrier film or barrier coating, temperature-related stresses between the different materials and flaking of the barrier film or barrier coating can be avoided. The main body preferably has a glass fiber content of 20% to 50%, particularly preferably of 30% to 40%. At the same time, the glass fiber content in the polymeric main body improves strength and stability.

In another preferred embodiment, the polymeric main body is filled with hollow glass spheres or glass bubbles. These hollow glass spheres have a diameter of 10 μm to 20 μm and improve the stability of the polymeric hollow profile. Suitable glass spheres are commercially available under the tradename “3M™ Glass Bubbles”. Particularly preferably, the polymeric main body contains polymers, glass fibers, and glass spheres. An admixture of glass spheres results in an improvement of the thermal properties of the hollow profile.

In an alternative preferred embodiment, the polymeric main body is made of wood or wood/polymer mixtures. Wood has low thermal conductivity and is, as a renewable resource, particularly sustainable ecologically.

The polymeric main body preferably has, along the glazing interior surfaces, a total width of 10 mm to 50 mm, particularly preferably of 20 mm to 36 mm. The distance between the first and the third pane or between the third and the second pane is determined by the selection of the width of the glazing interior surfaces. Preferably, the widths of the first glazing interior surface and of the second glazing interior surface are the same. Alternatively, asymmetric spacers are also possible, whereby the two glazing interior surfaces have different widths. The exact dimensions of the glazing interior surfaces are governed by the dimensions of the insulating glazing unit and the desired sizes of the interpane space.

The polymeric main body preferably has an overall height h_{G} of 8.5 mm to 15 mm. The overall height h_{G} corresponds to the distance between the glazing interior surfaces and the bearing edge.

The groove preferably has a depth h_{N} of 7.5 mm to 14 mm, particularly preferably of 7.5 mm to 9.5 mm. Thus, stable fixing of the third pane can be achieved. Alternatively, the groove can preferably also have a smaller depth than 7.5 mm. This is particularly suitable with a desired increase in the wall thickness d_{B} in the region of the bottom surface of the groove, by which means the stabilization of the weight of a middle pane can be improved.

The wall thickness d of the polymeric main body is preferably 0.5 mm to 1.5 mm, particularly preferably 0.7 mm to 1.2 mm.

The wall thickness d_{B} in the region of the bottom surface of the groove or in the region of the bearing edge is preferably just as great as the wall thickness of the polymeric main body. Thus, the depth of the groove is maximal, by which means the pane can be particularly well fixed. In another advantageous embodiment, the wall thickness d_{B} is greater than the wall thickness d of the polymeric main body in order to obtain improved stabilization of the middle pane. The depth of the groove is, to be sure, reduced, but the stability of the hollow profile in the region of the groove is advantageously increased such that the weight of the middle pane can be better supported.

The bearing edge is at least 3 mm wide, preferably between 3 mm and 10 mm wide. With these dimensions, the middle pane can be well stabilized.

The polymeric main body preferably contains a desiccant, preferably silica gels, molecular sieves, CaCl₂, Na₂SO₄, activated carbon, silicates, bentonites, zeolites, and/or mixtures thereof. These desiccants have proved to be particularly suitable. Preferably, the desiccant is situated in the first and second hollow chambers of the main body. Due to the angled geometry of the outer surfaces, the hollow chambers have a particularly large volume and, consequently, can accommodate much desiccant. A larger amount of desiccant extends the service life of the insulating glazing unit.

In a preferred embodiment, the first glazing interior surface and/or the second glazing interior surface has at least one opening. Preferably, a plurality of openings are made in both glazing interior surfaces. The total number of openings depends on the size of the insulating glazing unit. The openings connect the hollow chambers to the interpane spaces, making a gas exchange between them possible. Thus, absorption of atmospheric moisture by a desiccant situated in the hollow chambers is permitted and, hence, fogging of the panes is prevented. The openings are preferably implemented as slits, particularly preferably as slits with a width of 0.2 mm and a length of 2 mm. The slits ensure optimum air exchange without the desiccant being able to penetrate out of the hollow chambers into the interpane spaces.

In an alternative embodiment, the polymeric main body includes more than one groove. The spacer can thus accommodate more than one middle pane and be used for producing multipane insulating glazing units with more than three panes.

The invention further includes a method for producing an insulating glazing unit according to the invention comprising the steps:
a) Inserting the third pane into the groove of the spacer,
b) Bonding the first pane to the first pane contact surface of the spacer via a seal,
c) Bonding the second pane to the second pane contact surface of the spacer via a seal, and
d) Pressing the pane arrangement,
e) Filling the outer interpane spaces at least partially with an outer seal.

After insertion of the third pane into the groove of the spacer, this preassembled component can be processed in a conventional double glazing system known to the person skilled in the art. The costly Installation of additional system components or a loss of time with multiple passes through the system as with the use of multiple spacers can thus be avoided. Furthermore, even with the use of low-E or other functional coatings on the third pane in accordance with the method according to the invention, no prestressing of the third pane is necessary since the spacer with the insert according to the invention fixes the pane tension-free in its circumference. With the use of a spacer for an insulating glazing unit according to the prior art, which accommodates a third pane in a groove, a failure of the seal between the pane contact surfaces and the first and the second pane can occur due to the additional weight of the third pane. This results, during the production of the insulating glazing unit according to the prior art, in sagging of the spacer frame with the third pane. This sagging or slippage is prevented by the bearing edge of the spacer of the insulating glazing unit according to the invention, which is arranged flush with the edges of the panes, as a result of which otherwise required measures for supporting the frame before and after the pressing of the panes become superfluous. In addition, slippage of the spacer frame while the outer seal cures is prevented. The production of a triple glazing unit can thus be significantly improved and simplified.

Since, with the use of the spacer in the insulating glazing unit according to the invention, two individual interpane spaces are created, filling with the material of the outer seal can be performed with a standard device for triple insulating glazing units. These systems usually use two nozzles, which are in each case guided along between an outer pane and the adjacent middle pane, with the two pane edges serving as a guide. The outer edge of the spacer assumes the function of the middle pane and serves as a guide for the nozzles for the filling of the outer interpane spaces with the material of the outer seal. Thus, the production of a triple glazing unit is further improved.

In a preferred embodiment of the method, the spacer is first preshaped to form a rectangle open on one side. Here, for example, three spacers can be provided with a miter cut and linked at the corners by corner connectors. Instead of this, the spacers can also be directly welded to one another, for example, by ultrasonic welding. The third pane is slid into the groove of the spacer starting from the open side of the arrangement into the spacer arranged in the shape of a U. The remaining open edge of the third pane is then also closed with a spacer. Optionally, before the assembly of the spacer, an insert can be applied on the pane edge. Thereafter, the processing of the preassembled component is done in accordance with the method according to the invention, wherein, in the next step, the first pane is mounted on the first pane contact surface.

Preferably, the inner interpane spaces between the first pane and the third pane as well as between the second pane and the third pane are filled with a protective gas before the pressing of the pane arrangement.

The invention further includes the use of a spacer for the insulating glazing unit according to the invention in insulating glazing units, particularly preferably in triple insulating glazing units.

The invention is explained in detail in the following with reference to drawings. The drawings are purely schematic representations and are not true to scale. They in no way restrict the invention. They depict:

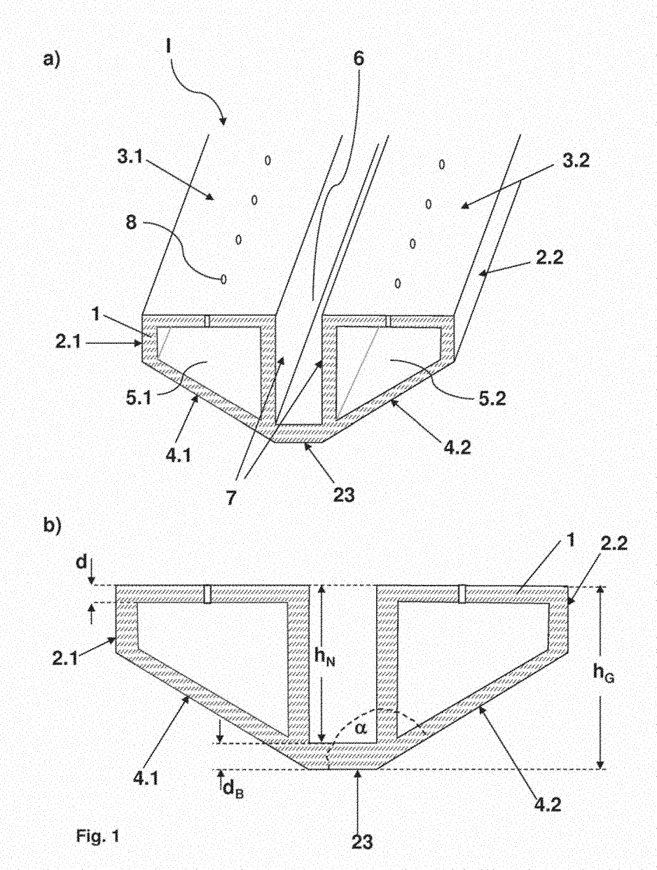

FIG. 1 a possible embodiment of the spacer for the insulating glazing unit according to the invention,

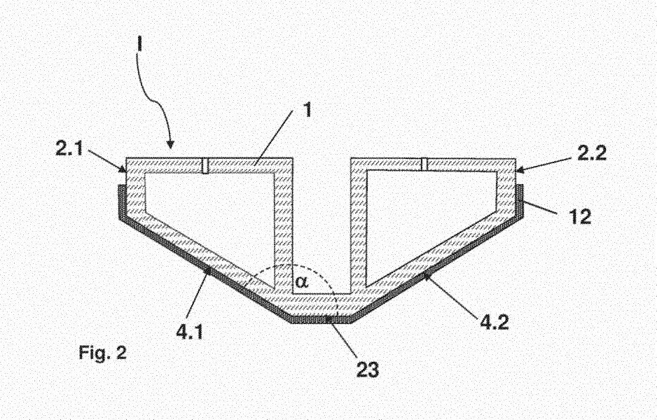

FIG. 2 a cross-section another possible embodiment of the spacer for the insulating glazing unit according to the invention,

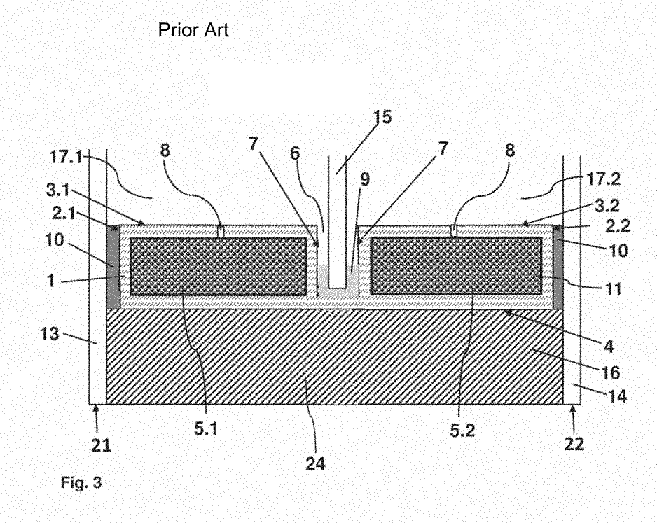

FIG. 3 a cross-section of an insulating glazing unit according to the prior art,

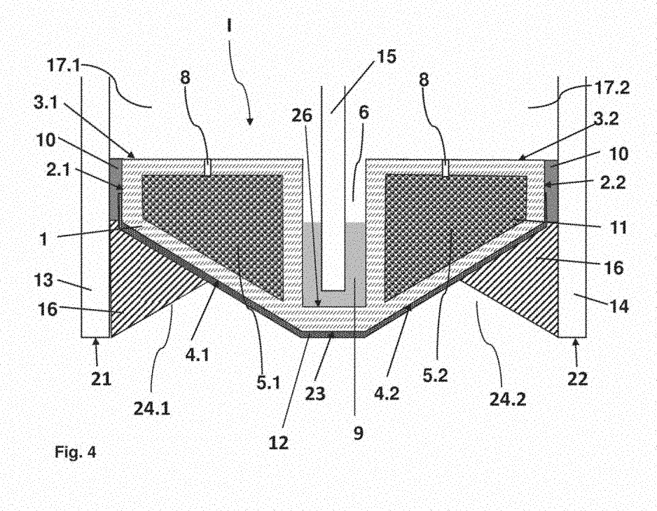

FIG. 4 a cross-section of a possible embodiment of the insulating glazing unit according to the invention,

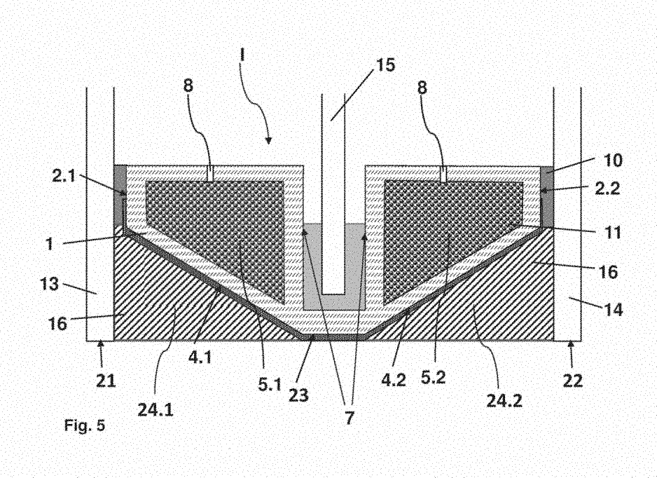

FIG. 5 a cross-section of another possible embodiment of the insulating glazing unit according to the invention, and

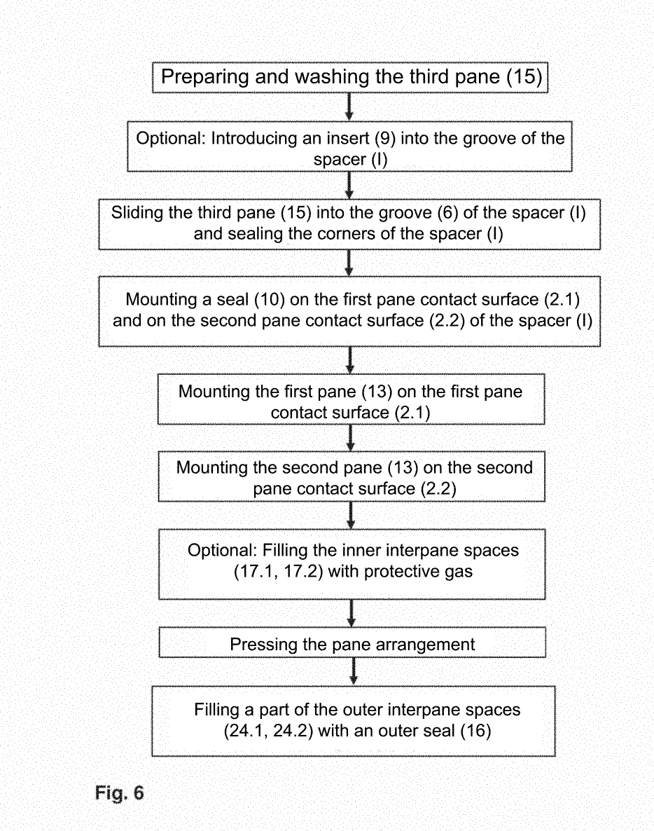

FIG. 6 a flowchart of a possible embodiment of the method according to the invention.

FIG. 1a,b depicts two cross-sections of the spacer I for the insulating glazing unit according to the invention. The glass fiber reinforced polymeric main body 1 comprises a first pane contact surface 2.1, a second pane contact surface 2.2 running parallel thereto, a first glazing interior surface 3.1, a second glazing interior surface 3.2, and an outer surface, which is divided into three sections: a first outer surface 4.1, a bearing edge 23, and a second outer surface 4.2. The bearing edge 23 runs perpendicular to the pane contact surfaces 2.1 and 2.2. and connects the first outer surface 4.1 and the second outer surface 4.2 to one another. A first hollow chamber 5.1 is situated between the first outer surface 4.1 and the first glazing interior surface 3.1, while a second hollow chamber 5.2 is arranged between the second outer surface 4.2 and the second glazing interior surface 3.2. The groove 6 that runs parallel to the pane contact surfaces 2.1 and 2.2 is situated between the two hollow chambers 5.1 and 5.2. The lateral flanks 7 of the groove 6 are formed by the walls of the two hollow chambers 5.1 and 5.2, while the bottom surface of the groove 6 is adjacent the outer edge 23. The wall thickness d of the polymeric main body is 1 mm. In the region of the bearing edge 23, the wall thickness d_{B} is 1.2 mm and is thus additionally reinforced, as result of which a third pane 15 can be better stabilized in the groove 6. The first outer surface 4.1 and the second outer surface 4.2 enclose in each case an angle α of roughly 150° with the edge 23. This angled geometry improves the stability of the polymeric main body 1. The polymere main body 1 contains styrene acrylonitrile (SAN) with roughly 35 wt.-% glass fiber. The glazing interior surfaces 3.1 and 3.2 have, at regular intervals, openings 8, which connect the hollow chambers 5.1 and 5.2 to the air space above the glazing interior surfaces 3.1 and 3.2. The spacer I has an overall height h_{G} of 12 mm and an overall width of 36 mm. The first glazing interior surface 3.1 is 16 mm wide and the second glazing interior surface 3.2 is 16 mm wide. The overall width of the spacer I equals the sum of the widths of the glazing interior surfaces 3.1 and 3.2 and of the thickness of the third pane 15 to be inserted into the groove 6. The bearing edge 23 is roughly 5 mm wide. The depth of the groove h_{N} equals the difference of the overall height of the polymeric main body h_{G} and the wall thickness in the region of the bearing edge d_{B}.

FIG. 2 depicts a cross-section of the spacer I for the insulating glazing unit according to the invention. The spacer depicted essentially corresponds to the spacer depicted in FIG. 1. A gas-and vapor-tight barrier film 12 is mounted on the first outer surface 4.1, the bearing edge 23, and the second outer surface 4.2. The barrier film 12 also extends over roughly 50% of the first and second pane contact surfaces 2.1 and 2.2. Thus, particularly good sealing of the spacer I is obtained. The barrier film 12 can be fastened on the polymeric main body 1, for example, with a polyurethane hotmelt adhesive. The barrier film 12 comprises four polymeric layers of polyethylene terephthalate with a thickness of 12 μm and three metallic layers of aluminum with a thickness of 50 nm. The metallic layers and the polymeric layers are alternatingly applied in each case, with the two outer layers being formed by polymeric layers.

FIG. 3 depicts a cross-section through an insulating glazing unit according to the prior art. The polymeric main body 1 comprises a first pane contact surface 2.1, a second pane contact surface 2.2 running parallel thereto, a first glazing interior surface 3.1, a second glazing interior surface 3.2, and an outer surface 4. The entire outer surface 4 runs perpendicular to the pane contact surfaces 2.1, 2.2 and connects the pane contact surfaces 2.1. 2.2. A first hollow chamber 5.1 is situated between tthe outer surface 4 and the first glazing interior surface 3.1, while a second hollow chamber 5.2 is arranged between the outer surface 4 and the second glazing interior surface 3.2. A groove 6 that runs parallel to the pane contact surfaces 2.1 and 2.2 is situated between the two hollow chambers 5.1 and 5.2. The lateral flanks 7 of the groove 6 are formed by the walls of the two hollow chambers 5.1 and 5.2. The first pane 13 of the triple insulating glazing unit is bonded via a seal 10 to the first pane contact surface 2.1 of the spacer I, while the second pane 14 is bonded via a seal 10 to the second pane contact surface 2.2. The intermediate space between the first pane 13 and the third pane 15 delimited by the first glazing interior surface 3.1 is defined as the first inner interpane space 17.1, and the space between the third pane 15 and the second pane 14 delimited by the second glazing interior surface 3.2 is defined as the second inner interpane space 17.2. The inner interpane spaces 17.1 and 17.2 are connected via the openings 8 in the glazing interior surfaces 3.1 and 3.2 with the respective underlying hollow chamber 5.1 or 5.2. A desiccant 11 is situated in the hollow chambers 5.1 and 5.2. A third pane 15 is inserted into the groove 6 of the spacer via an insert 9 made of a sealant, which fixes the third pane and hermetically separates the two inner interpane spaces 17.1, 17.2 from one another. The depth of the groove 6 is less than the height of the pane contact surfaces 2.1, 2.2. With a height of the pane contact surfaces of roughly 5 mm, the pane can be stabilized depending on the wall thickness of the polymeric main body over a height of at most 4 mm by the lateral flanks of the groove 7. The outer interpane space 24, which is delimited by the outer surface 4 and the first pane 13 and the second pane 14, is completely filled with an outer seal 16.

FIG. 4 depicts a cross-section of an insulating glazing unit according to the invention. The spacer I corresponds to the spacer described in FIG. 2. The first pane 13 of the triple insulating glazing unit is bonded via a seal 10 to the first pane contact surface 2.1 of the spacer I, while the second pane 14 is bonded via a seal 10 to the second pane contact surface 2.2. The seal 10 is made of a polyisobutylene. The insert 9 encloses the edge of the third pane 15 and fits flush into the groove 6. The Insert 9 is made of butyl rubber and covers the bottom surface 26 and a part of the lateral flanks 7. The insert 9 fixes the third pane 15 without stress and compensates thermal expansion of the pane. Moreover, the insert 9 prevents development of noise from slippage of the third pane 15. The insert 9 is applied such that a gas exchange is possible between the two inner interpane spaces 17.1, 17.2. For this, the insert 9 is not inserted continuously along the entire spacer profile, but, rather, divided into a plurality of parts. Where no insert 9 is installed, a gas exchange and, hence, pressure equalization between the inner interpane spaces 17.1 and 17.2 can occur. The inner interpane spaces 17.1 and 17.2 are connected to the respective underlying hollow chamber 5.1 or 5.2 via the openings 8 in the glazing interior surfaces 3.1 and 3.2. A desiccant 11 that is made of a molecular sieve is situated in the hollow chambers 5.1 and 5.2. A gas exchange between the hollow chambers 5.1, 5.2 and the inner interpane spaces 17.1 and 17.2 takes place through the openings 8, with the desiccant 11 withdrawing the atmospheric moisture from the inner interpane spaces 17.1 and 17.2. The first pane 13 and the second pane 14 protrude beyond the pane contact surfaces 2.1 and 2.2. The edge of the first pane 21, the edge of the second pane 22, and the bearing edge 23 are arranged at one height. The first outer surface 4.1 and the first pane 13 delimit the first outer interpane space 24.1, and the second outer surface 4.2 and the second pane 14 delimit the second outer interpane space 24.2. An outer seal 16 is installed in the outer interpane spaces 24.1, 24.2. This outer seal 16 is formed from an organic polysulfide. The outer seal 16 completely covers the part of the first pane 13 that delimits the first outer interpane space 24.1 and covers the first outer surface 4.1 by roughly 50%. Thus, the edge bond can be excellently stabilized mechanically. At the same time, compared to completely filled outer interpane spaces 24.1, 24.2, outer seal 16 can be economized. Since the outer seal 16 is adjacent the seal 10, the edge bond is additionally sealed. The barrier 12, which is implemented as described in FIG. 2, adequately seals the spacer I even in the regions without outer seal 16. The thermal conductivity of the outer seal 16 is higher than that of the polymeric main body 1. Due to the separated interpane spaces 24.1, 24.2, the insulating glazing unit according to the invention has improved insulation properties compared to an insulating glazing unit according to the prior art, since thermal decoupling takes place by means of the separation. As is depicted in FIG. 3, insulating glazing units according to the prior art have a continuous outer interpane space 24 between the first pane 13 and the second pane 14 that is filled with the outer seal.

The geometry of the spacer I in the insulating glazing unit according to the invention further results in an improvement of the stabilization of the third pane 15 in the groove 6. The distance between the glazing interior surfaces 3.1, 3.2 and the edges of the outer panes 21, 22 is dictated by the subsequent window frame, because the seal 10 and the seal 16 are to be covered by the window frame of the finished insulating glass window. In the insulating glazing unit according to the invention, this region is optimally utilized for stabilization of the third pane 15 in the groove 6, since the depth of the groove h_{N} is maximized. With the prior art insulating glazing unit, a much smaller depth of the groove h_{N} is obtained and, thus, poorer stabilization of the third pane 15.

Due to the geometry of the spacer I of the insulating glazing unit according to the invention, the volume of the hollow chambers 5.1, 5.2 is also increased in comparison with a prior art insulating glazing unit, as depicted in FIG. 3. More desiccant 11 can be accommodated in the enlarged hollow chambers 5.1, 5.2, as a result of which the service life of the insulating glazing unit is increased. The first pane 13 and the second pane 14 are made of soda lime glass with a thickness of 3 mm, while the third pane 15 is formed from soda lime glass with a thickness of 2 mm.

FIG. 5 depicts an alternative embodiment of an insulating glazing unit according to the invention. The insulating glazing unit corresponds essentially to that depicted in FIG. 4. The outer interpane spaces 24.1, 24.2 are completely filled with the outer seal 16. Thus, optimum mechanical stabilization of the edge bond is obtained. In comparison with a prior art spacer as depicted in FIG. 3, outer seal 16 is spared.

FIG. 6 depicts a flowchart of a possible embodiment of the method according to the invention. First, the polymeric main body 1 is prepared and, if need be, provided with an insert 9. Then, the third pane 15 is prepared and washed. The third pane 15 is now slid into the groove 6 of the spacer I according to the invention. Here, for example, three spacers I can be preformed into a rectangle open on one side, with the third pane 15 slid into the groove 6 via the open side. Then, the fourth pane edge is closed with a spacer I. The corners of the spacer are either welded or linked via corner connectors. These first three process steps serve for preparation of a third pane 15 with spacer I. Such a preassembled component can then be further processed in a conventional double glazing system. The assembly of the first pane 13 and the second pane 14 on the pane contact surfaces 2.1 and 2.2 is done in the double glazing system via a seal 10 in each case. Using the bearing edge 23, the spacer I with an integrated third pane 15 can be positioned without additional equipment. Optionally, a protective gas can be introduced into the interpane spaces 17.1 and 17.2. Then, the insulating glazing unit is pressed. In the last step, an outer seal 16 is filled into the outer interpane spaces 24.1 and 24.2 and the finished insulating glazing unit is placed on a rack to dry.

In the following, other preferred embodiments of the invention are presented

### Embodiment 1

Spacer (I) for insulating glazing units, at least comprising a polymeric main body (1) comprising a first pane contact surface (2.1) and a second pane contact surface (2.2) running parallel thereto, a first glazing interior surface (3.1), a second glazing interior surface (3.2), an outer surface (4), a first hollow chamber (5.1), and a second hollow chamber (5.2), wherein
a groove (6) to accommodate a pane runs parallel to the first pane contact surface (2.1) and the second pane contact surface (2.2) between the first glazing interior surface (3.1) and the second glazing interior surface (3.2),
the first hollow chamber (5.1) is adjacent the first glazing interior surface (3.1), and the second hollow chamber (5.2) is adjacent the second glazing interior surface (3.2),
the lateral flanks (7) of the groove (6) are formed by the walls of the first hollow chamber (5.1) and of the second hollow chamber (5.2),
the outer surface (4) is divided into a first outer surface (4.1), a second outer surface (4.2), and a bearing edge (23),
the bearing edge (23) runs substantially perpendicular to the pane contact surfaces and connects the first outer surface (4.1) and the second outer surface (4.2) to one another,
the first outer surface (4.1) and the second outer surface (4.2) enclose in each case an angle α (alpha) of 100°<α<160° with the bearing edge (23).

### Embodiment 2

Spacer (I) for insulating glazing units according to embodiment 1), wherein the bottom surface (26) of the groove (6) is adjacent the bearing edge (23) of the polymeric main body (1).

### Embodiment 3

Spacer (I) for insulating glazing units according to one of the embodiments 1) or 2), wherein the angle α (alpha) is between 130° and 150°.

### Embodiment 4

Spacer (I) for an insulating glazing unit according to one of the embodiments 1 through 3, wherein a gas- and vapor-tight barrier (12) is mounted on the first outer surface (4.1), the second outer surface (4.2), the bearing edge (23) of the polymeric main body (1), and at least a part of the pane contact surfaces (2.1, 2.2).

### Embodiment 5

Spacer (I) for insulating glazing units according to embodiment 4, wherein the gas- and vapor-tight barrier (12) is implemented as a barrier film that comprises at least one polymeric layer as well as one metallic layer or one ceramic layer, preferably at least two metallic layers and/or ceramic layers, that are arranged alternatingly with at least one polymeric layer.

### Embodiment 6

Spacer (I) for insulating glazing units according to embodiment 4, wherein the gas- and vapor-tight barrier (12) is implemented as a coating that contains aluminum, aluminum oxides, and/or silicon oxides and is preferably applied by a PVD method (physical vapor deposition).

### Embodiment 7

Spacer (I) for insulating glazing units according to one of the embodiments 1 through 6, wherein an insert (9), preferably an insert (9) containing an elastomer, particularly preferably containing butyl rubber, is installed in the groove (6).

### Embodiment 8

Spacer (I) for insulating glazing units according to one of the embodiments 1 through 7, wherein the polymeric main body (1) contains polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), preferably acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

### Embodiment 9

Insulating glazing unit, at least comprising a first pane (13), a second pane (14) and a third pane (15), and a circumferential spacer (I) according to one of the embodiments 1 through 8, wherein
the first pane (13) is bonded via a seal (10) to the first pane contact surface (2.1),
the second pane (14) is bonded via a seal (10) to the second pane contact surface (2.2),
the third pane (15) is inserted into the groove (6) of the spacer (I),
the edge of the first pane (21), the edge of the second pane (22), and the bearing edge (23) are arranged flush, wherein the first pane (13) and the first outer surface (4.1) delimit a first outer interpane space (24.1) and the second pane (14) and the second outer surface (4.2) delimit a second outer interpane space (24.2), and
the outer interpane spaces (24.1, 24.2) are at least partially filled with an outer seal (16) that is adjacent the seal (10).

### Embodiment 10

Insulating glazing unit according to embodiment 9, wherein the outer seal (16)
covers the part of the first pane (13) that delimits the first outer interpane space (24.1) by at least 90%,
covers the part of the second pane (14) that delimits the second outer interpane space (24.2) by at least 90%,
covers in each case the first outer surface (4.1) and the second outer surface (4.2) by at least 40% and at most 60%.

### Embodiment 11

Insulating glazing unit according to embodiment 9, wherein the outer seal (16) fills the outer interpane spaces (24.1,24.2) substantially completely.

### Embodiment 12

Insulating glazing unit according to one of the embodiments 9 through 11, wherein at least one insert (9) is installed in the groove (6) such that a gas exchange is possible between the two inner interpane spaces (24.1, 24.2).

### Embodiment 13

Method for producing an insulating glazing unit according to one of the embodiments 9 through 12, wherein at least
a) the third pane (15) is inserted into the groove (6) of the spacer (I),
b) the first pane (13) is bonded to the first pane contact surface (2.1) of the spacer (I) via a seal (10),
c) the second pane (14) is bonded to the second pane contact surface (2.2) of the spacer (I) via a seal (10),
d) the pane arrangement comprising the panes (13, 14, 15) and the spacer (I) is pressed together, and
e) the outer interpane spaces (24.1, 24.2) are at least partially filled with an outer seal (16).

### Embodiment 14

Use of a spacer (I) according to one of the embodiments 1 through 8 in insulating glazing units, preferably in triple insulating glazing units.

### LIST OF REFERENCE CHARACTERS

I spacer
1 polymeric main body
2 pane contact surfaces
2.1 first pane contact surface
2.2 second pane contact surface
3 glazing interior surfaces
3.1 first glazing interior surface
3.2 second glazing interior surface
4 outer surface
4.1 first outer surface
4.2 second outer surface
5 hollow chambers
5.1 first hollow chamber
5.2 second hollow chamber
6 groove
7 lateral flanks
8 openings
9 Insert
10 seal
11 desiccant
12 barrier/barrier film /barrier coating
13 first pane
14 second pane
15 third pane
16 outer seal
17 inner interpane space
17.1 first inner interpane space
17.2 second inner interpane space
21 edge of the first pane
22 edge of the second pane
23 bearing edge
24 outer interpane space
24.1 first outer interpane space
24.2 second outer interpane space
26 bottom surface of the groove
d wall thickness of the polymeric main body
d_{B} wall thickness in the region of the edge of the polymeric main body
h_{N} depth of the groove
h_{G} overall height of the polymeric main body

1.-13. (canceled)

14. An insulating glazing unit, comprising
a first pane, a second pane, a third pane, and a circumferential spacer, the spacer including:
a polymeric main body having a first pane contact surface and a second pane contact surface running parallel thereto, a first glazing interior surface, a second glazing interior surface, an outer surface, a first hollow chamber, and a second hollow chamber, wherein:
a groove to accommodate the third pane runs parallel to the first pane contact surface and the second pane contact surface between the first glazing interior surface and the second glazing interior surface,
the first hollow chamber is adjacent the first glazing interior surface, and the second hollow chamber is adjacent the second glazing interior surface,
lateral flanks of the groove are formed by walls of the first hollow chamber and of the second hollow chamber,
the outer surface is divided into a first outer surface, a second outer surface, and a bearing edge,
the bearing edge runs substantially perpendicular to the pane contact surfaces and connects the first outer surface and the second outer surface to one another,
the first outer surface and the second outer surface enclose angles a (alpha) with the bearing edge, the angles a being between 100° and 160°,
wherein:
the first pane is bonded via a seal to the first pane contact surface;
the second pane is bonded via a seal to the second pane contact surface;
the third pane is inserted into the groove of the spacer;
an edge of the first pane, an edge of the second pane, and the bearing edge are arranged flush;
the first pane and the first outer surface delimit a first outer interpane space and the second pane and the second outer surface delimit a second outer interpane space; and
the first and second outer interpane spaces are at least partially filled with an outer seal, the outer seal in the first outer interpane space being adjacent the seal to the first contact surface, and the outer seal in the second outer interpane space being adjacent to the seal to the second pane contact surface.

15. The insulating glazing unit according to claim 14, wherein:
the outer seal covers a part of the first pane that delimits the first outer interpane space by at least 90%;
the outer seal covers a part of the second pane that delimits the second outer interpane space by at least 90%; and
the outer seal covers in each case the first outer surface and the second outer surface by at least 40% and at most 60%.

16. The insulating glazing unit according to claim 14, wherein the outer seal fills the first and second outer interpane spaces substantially completely.

17. The insulating glazing unit according to claim 14, wherein at least one insert is mounted in the groove, configured to provide a gas exchange between a first inner interpane space and a second inner interpane space.

18. The insulating glazing unit according to claim 14, wherein the bottom surface of the groove is adjacent to the bearing edge of the polymeric main body.

19. The insulating glazing unit according to claim 14, wherein the angles a (alpha) are between 130° and 150°.

20. The insulating glazing unit according to claim 14, wherein a gas-tight and vapor-tight barrier is mounted on the first outer surface, the second outer surface, the bearing edge of the polymeric main body, and at least a part of the pane contact surfaces.

21. The insulating glazing unit according to claim 20, wherein the barrier is a barrier film that comprises at least one polymeric layer and at least one metallic or ceramic layer.

22. The insulating glazing unit according to claim 21, wherein the at least one metallic or ceramic layer is at least two metallic or ceramic layers, the at least one metallic or ceramic layer being arranged alternatingly with the at least one polymeric layer.

23. The insulating glazing unit according to claim 20, wherein the barrier is a coating that contains aluminum, aluminum oxides, or silicon oxides and is applied by a PVD method (physical vapor deposition).

24. The insulating glazing unit according to claim 14, wherein an insert is installed in the groove.

25. The insulating glazing unit according to claim 24, wherein the insert contains an elastomer.

26. The insulating glazing unit according to claim 24, wherein the insert contains butly rubber.

27. The insulating glazing unit according to claim 14, wherein the polymeric main body contains polyethylene (PE), polycarbonates (PC), polypropylene (PP), polystyrene, polybutadiene, polynitriles, polyesters, polyurethanes, polymethylmethacrylates, polyacrylates, polyamides, polyethylene terephthalate (PET), polybutylene terephthalate (PBT), acrylonitrile butadiene styrene (ABS), acrylonitrile styrene acrylester (ASA), acrylonitrile butadiene styrene/polycarbonate (ABS/PC), styrene acrylonitrile (SAN), PET/PC, PBT/PC, and/or copolymers or mixtures thereof.

28. A method for producing the insulating glazing unit according to claim 14, comprising:
inserting the third pane into the groove of the spacer;
bonding the first pane to the first pane contact surface of the spacer via the seal;
bonding the second pane to the second pane contact surface of the spacer via the seal;
pressing the first, second and third panes together with the spacer; and
filling the outer interpane spaces, at least partially, with the outer seal.

29. The method according to claim 28, further comprising using the insulating glazing unit as a building interior glazing, or a building exterior glazing, or a facade glazing.
